(19) United States
(12) Patent Application Publication
(10) Pub. No.: US 2026/0004075 A1
(43) Pub. Date: Jan. 1, 2026

(54) TEXT CLASSIFICATION WITH WEIGHTED EMBEDDINGS

(71) Applicant: INTUIT INC., Mountain View, CA (US)

(72) Inventors: Yair HORESH, Kfar-Saba (IL); Aleksandr KIM, Tel Aviv (IL); Itay MARGOLIN, Petah Tikva (IL); Guy SHTAR, Ness Ziona (IL); Meghan MERGUI, Ramat Gan (IL)

(21) Appl. No.: 18/758,291

(22) Filed: Jun. 28, 2024

(51) Int. Cl. G06F 40/289; G06F 40/30; G06N 3/0455; G06N 3/09

(52) U.S. Cl. CPC G06F 40/289; G06F 40/30; G06N 3/0455; G06N 3/09

(57) ABSTRACT

Aspects of the present disclosure relate to automated transaction categorization. Embodiments include generating, via an embedding model, a first embedding representation of a training text; assigning, via a text classification model, a class to the training text based on the first embedding representation of the training text; generating an embedding representation of a given phrase within the training text based on confirming that the class assigned to the training text is an incorrect class for the training text, wherein the given phrase is selected based on an association between the given phrase and a correct class for the training text; generating an updated embedding representation of the training text based on the first embedding representation of the training text and the embedding representation of the given phrase; and training the text classification model through a supervised learning process involving the updated embedding representation of the training text.

### INTRODUCTION

Aspects of the present disclosure relate to techniques for training a text classification model to correctly classify texts. In particular, techniques described herein involve identifying phrases within texts that are relevant to a classification and creating weighted embedding representations of the texts that include specific weights for the identified phrases. A text classification model may be trained using these weighted embeddings, and the trained model may be used to classify texts.

### BACKGROUND

A growing number of people, businesses, and organizations around the world utilize embeddings for classification tasks. An embedding generally refers to a vector representation of an entity that represents the entity as a vector in n-dimensional space such that similar entities are represented by vectors that are close to one another in the n-dimensional space. For example, embeddings may be used to represent a text, and a machine learning model may classify the text based on the embedding of the text.

Embeddings may be generated through the use of an embedding model, such as a neural network or other type of machine learning model. However, in some instances, embeddings generated by machine learning models may be insufficient for performing classification tasks. As an example, embeddings created using a machine learning model that has not been trained with data related to a particular classification task may lack the refinement and specificity needed for the particular classification task. Existing solutions for this problem involve further training and/or fine-tuning of the embedding model to produce embeddings that are refined for the specific classification task. However, such training and/or fine-tuning may require a significant amount of time and resources both for obtaining the training data and for performing the training and/or fine-tuning. For instance, training an embedding model may require a much larger amount of data than training a simple classification model.

Thus, there is a need in the art for improved methods of classification model optimization.

### BRIEF SUMMARY

Certain embodiments provide a method of training a text classification model. The method generally includes: generating, via an embedding model, a first embedding representation of a training text; assigning, via a text classification model, a class to the training text based on the first embedding representation of the training text; generating, via the embedding model, an embedding representation of a given phrase within the training text based on confirming that the class assigned to the training text is an incorrect class for the training text, wherein the given phrase is selected based on an association between the given phrase and a correct class for the training text; generating an updated embedding representation of the training text based on the first embedding representation of the training text and the embedding representation of the given phrase; and training the text classification model through a supervised learning process involving the updated embedding representation of the training text.

Other embodiments provide a method of classifying text. The method generally includes: generating, via an embedding model, a first embedding representation of a given text; generating an updated embedding representation of the given text based on detecting a particular phrase of a set of phrases in the given text, wherein the set of phrases is selected based on an association between each phrase of the set of phrases and a correct class for a text that contains the phrase; and classifying the text based on the updated embedding representation of the given text using a text classification model, wherein the text classification model has been trained through a supervised learning process comprising: assigning, via the text classification model, a class to a training text based on a first embedding representation of the training text; generating, via the embedding model, an embedding representation of a given phrase of the set of phrases within the training text; generating an updated embedding representation of the training text based on the first embedding representation of the training text and the embedding representation of the given phrase; and training the text classification model using the updated embedding representation of the training text.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to text classification.

FIG. 2 depicts a sequence diagram for training a text classification model.

FIG. 3 depicts a sequence diagram for classifying texts using a trained text classification model.

FIG. 4 depicts example operations related to training a text classification model.

FIG. 5 depicts example operations related to classifying texts using a trained text classification model.

FIG. 6 depicts an example of a processing system for text classification.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training a text classification model and classifying text.

According to certain embodiments, a text classification model is trained based on weighted embeddings of training text. The weighted embeddings may be generated based on identifying a particular phrase within the text that is associated with a correct class (e.g., the identified phrase may be a key phrase that indicates that the text belongs in the correct class). An embedding of the identified phrase may be combined with an embedding of the text to create an updated embedding representation of the text. Each of the embeddings within the updated representation may be assigned a weight. A text classification model, such as a machine learning model, may be trained based on the updated embedding representation, and this training may result in a text classification model that is fine-tuned for the specific classification task.

Certain embodiments provide that a text classification model, such as the fine-tuned model discussed above, may be used to classify text. The classification may be based on identifying key phrases (e.g., the key phrases discussed above) within the text, such as by searching an embedding representation of the text. An updated embedding representation of the text may be created by combining an embedding representation of the key phrase with the original embedding representation of the text. The text classification model may assign a class to the text based on the updated embedding representation of the text.

In some embodiments, an embedding representation of a text such as a training text may be generated. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities.

According to some embodiments, a text may comprise written words. Examples of texts include phrases, sentences, paragraphs, and/or the like. Training texts may further comprise labels that indicate a class to which the text belongs (e.g., ground-truth labels used for training a classification model).

In certain embodiments, the text classification model may be used to assign a class to a text such as a training text based on the embedding representation of the text. The text classification model may be a machine learning model, such as a neural network, that is trained to classify texts based on embedding representations of texts. As an example, a classification model may be trained to recognize questions submitted by users of a software application. One class may correspond to questions, and another class may correspond to texts that are not questions. If a user submits a question, the text classification model may assign the user's submission to the class that corresponds to questions.

Some embodiments provide that a key phrase within a text may be selected based on an association between the phrase and the correct class for the text. A selected key phrase may comprise one or more words within a text. As an example, when classifying texts as either questions or non-questions, the phrase “how many” may be selected from the text “how many ounces are in a gallon.” In this example, “how many” is selected as the key phrase because the phrase “how many” provides an indication that the text is a question. Key phrase selection may be performed manually or automatically, such as by using a machine learning model that is trained to identify key phrases within texts.

Certain embodiments provide that key phrases are selected based on a text classification model incorrectly classifying a training text. For example, the text classification model may be used to assign classes to each training text, and the training texts that are incorrectly classified may be identified. Then, key phrases may be selected for each of the texts that were incorrectly classified. Other embodiments provide that key phrases may be identified for correctly classified texts as well.

Some embodiments provide that key phrases of a list of key phrases may be identified within a text, such as based on applying a semantic similarity algorithm to an embedding representation of a text. The list of key phrases may be phrases identified as being associated with a correct class for a text. A semantic similarity algorithm may scan an embedding representation of a text to identify a key phrase within the text. Other techniques for identifying phrases within texts based on embedding representations of the texts may be used as well.

In certain embodiments, an embedding representation of the identified key phrase is generated. The embedding representation of the key phrase may be combined with the embedding representation of the text to create an updated embedding representation of the text in which the key phrase has extra weight. For example, the embedding representation of the key phrase may be concatenated to the embedding representation of the text, and the embedding representation of the key phrase and the embedding representation of the text may each be assigned a weight (e.g., 0.1 and 0.9 respectively). The weight of the key phrase embedding may be increased based on the importance of the key phrase. For example, identifying the key phrase may further comprise determining a level of importance for the key phrase, and the key phrase may be assigned a weight based on the determined level of importance. As another example, the weights may be adjusted based on the results of classification (e.g., the weights of key phrases may be iteratively increased or decreased based on incorrect classifications of texts).

Certain embodiments provide that more than one key phrases may be identified for a given text. In such embodiments, the weight associated with key phrases may be split between the key phrases. For example, 0.8 may be the weight allocated for the original text embedding and 0.2 may be the weight allocated for key phrase embeddings. Thus, if there are two key phrases, the weight of each key phrase may be 0.1. Alternatively, a given weight may be allocated for each key phrase. For example, 0.2 may be the weight allocated for each key phrase. Thus, if there are two key phrases, the weight for each key phrase may be 0.2 and the weight for the original text embedding may be 0.6. Other weight combinations are possible. For example, a weight of zero may be assigned to the original text and a weight of one may be assigned to the key phrase.

According to some embodiments, phrases that are not relevant for classification may be identified. These phrases may be assigned a low weight or a weight of zero such that they may be given less consideration by the classification model. In such embodiments, creating the updated embedding representation of the text may be further based on the selected irrelevant phrase (e.g., by concatenating the low or zero weighted embedding representation of the irrelevant phrase to the embedding representation of the text).

In some embodiments, the text classification model may be trained based on the updated embedding representation of a training text. For example, the training may include a supervised learning process. The supervised learning process may comprise providing an updated embedding representation of a training text to the text classification model and iteratively updating parameters of the classification model until the model assigns the correct class to the training text or until some other condition is met (e.g., related to optimizing a cost function). This training process may result in the text classification model being optimized for a particular classification task associated with the training text (e.g., the model may be more likely to assign a correct class to texts that contain the key phrase).

Certain embodiments provide that the trained text classification model is used to assign classes to given texts. For example, a text may be submitted by a user of a software application.

An embedding representation of the text may be generated. A key phrase may be identified within the text (e.g., based on the embedding representation). In some embodiments, the embedding representation may be scanned using a semantic similarity algorithm (e.g., a nearest neighbor algorithm) to identify key phrases within the text. Certain embodiments provide that a key phrase may be removed from a list of key phrases based on the key phrase appearing in two texts that have different classifications (e.g., because such a key phrase may not be indicative of a class for texts). An updated embedding representation of the text may be created based on the original embedding representation of the text and embedding representations of identified phrases and, in some embodiments, based on weights assigned to the original embedding representation of the text and embedding representations of the identified phrases. Then, the trained text classification model may classify the text based on the updated embedding representation of the text. In certain embodiments, the trained text classification model may classify the text without using an updated embedding representation of the text (e.g., in some cases an embedding representation of the text that is not weighted based on identified phrases may be used instead).

Embodiments of the present disclosure provide numerous technical and practical effects and benefits. For instance, when a text classification model is trained using embeddings of texts that have particular weights for key phrases associated with a classification task, the text classification model may achieve better results in performing the classification task. This improved performance can be achieved without retraining/fine-tuning an embedding model to produce embeddings that are specifically tailored to the classification task. Thus, teachings of the present disclosure allow for accurate text classification using a pretrained embedding model. Since training a word classification model requires less time and resources than training an embedding model, teachings of the present disclosure also improve the speed and efficiency of computing systems. Additionally, by identifying key phrases in texts that are provided as input to the text classification system and generating embedding representations of the texts that have a particular weight for the key phrase (e.g., such that the key phrase is given more consideration by the classification model than it would have if it were not separately weighted from the embedding of the overall text), teachings of the present disclosure further improve the accuracy of text classification systems. As an example, a text classification model will produce more accurate results when a key phrase that indicates a correct class is given a separate weight in an embedding of a text.

### Example of Computing Components Related to Training a Text Classification Model

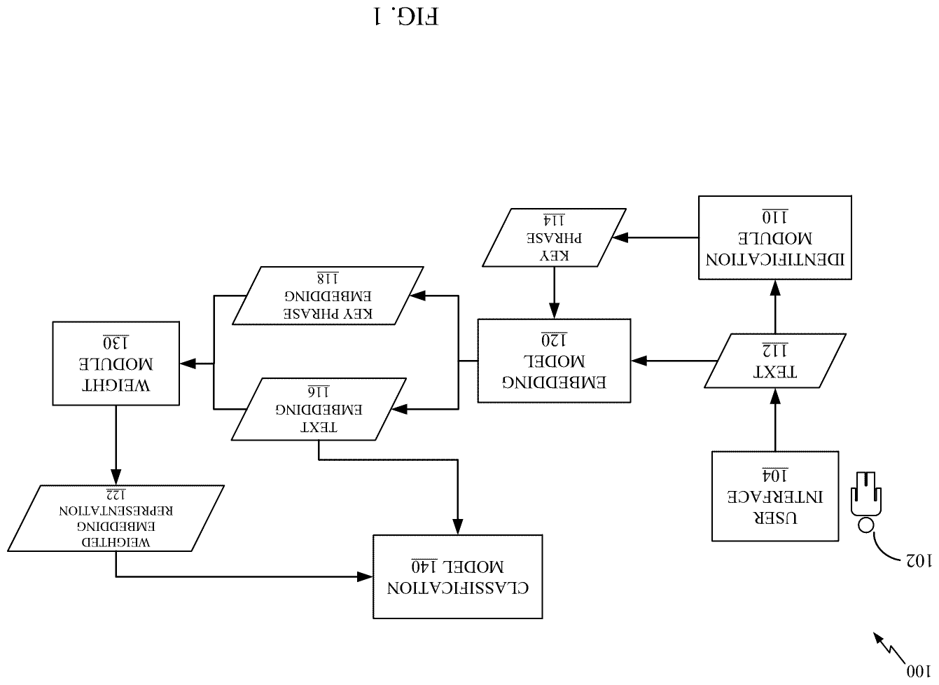

FIG. 1 depicts an example of computing components related to text classification.

A user 102 may interact with a text classification system 100 through a user interface 104. The user interface 104 may correspond to a software application that allows the user 102 to submit texts 112. Texts 112 are generally any collection of multiple written words, such as a phrase, sentence, paragraph, multiple paragraphs, and/or the like. For example, a text 112 submitted by a user 102 may be a question related to the software application. The text classification system 100 may allow for classifying the text 112. Such classification may be performed by classification model 140, discussed in further detail below.

When training classification model 140, text 112 may be a training text. Training texts may be texts that are associated with training labels that indicate a correct class for the text. The training text may be provided to an embedding model 120. Embedding model 120 may be a neural network or other type of machine learning model that learns a representation (embedding) for an entity through a training process that trains the neural network based on a data set, such as a plurality of features of a plurality of entities. In one example, embedding model 120 comprises a Bidirectional Encoder Representations from Transformer (BERT) model, which involves the use of masked language modeling to determine embeddings. In a particular example, embedding model 120 comprises a Sentence-BERT model. In other embodiments, embedding model 120 may involve embedding techniques such as Word2Vec and GloVe embeddings. These are included as examples, and other techniques for generating embeddings are possible.

When provided with a text, the embedding model 120 may generate an embedding representation of the text, represented here by text embedding 116. Text embeddings 116 may be provided to classification model 140. Classification model 140 may comprise any type of machine learning model that is capable of being trained to classify texts based on embeddings of the texts. For instance, classification model may be a neural network, a tree-based classifier, a Naïve Bayes classification model, a logistic regression model, and/or the like. When provided with a text embedding 116, classification model 140 may assign a class to the text associated with the embedding. As an example, a classification model 140 may be used to determine whether questions submitted by users 102 are ambiguous. Ambiguous questions may be assigned the ambiguous class, whereas unambiguous questions may be assigned the unambiguous class.

Training the classification model 140 may comprise providing the classification model 140 with an embedding representation of a training text. The classification model 140 may classify the training text, and if the training text is assigned the wrong class, then the training text may be provided to identification module 110. In some embodiments, training texts may be provided to identification module 110 without being assigned an incorrect class.

Identification module 110 may run on one or more processors, and may be configured to allow for identifying key phrases 114 in training texts that are associated with the correct class for the text. In an example where the classification model 140 is used to identify ambiguous questions related to income tax filing, a question submitted by a user 102 may be: “I just got married, should I submit my taxes as usual using a W2 form?” This question is ambiguous because of the presence of the phrase “just got.” For example, the answer to the question may change depending on whether “just got” means “after the previous tax year” or “during the previous tax year.” For this example, since “just got” is the phrase that makes the sentence ambiguous, “just got” may be identified as the key phrase 114 for the sentence. Key phrases 114 may be identified manually or automatically, such as by using a machine learning model within identification module 110 that is configured to identify key phrases for a given classification task and text. The key phrase may be provided to the embedding model 120, which may create a key phrase embedding 116.

The text embedding 116 and key phrase embedding 118 may be provided to weight module 130, which may run on one or more processors and may be configured to combine and assign weights to the text embedding 116 and the key phrase embedding 118. For example, the key phrase embedding 118 may be concatenated to the text embedding 116, and key phrase embedding 118 and the text embedding 116 may each be assigned a weight (e.g., 0.1 and 0.9 respectively). The weight of the key phrase embedding 118 may be increased based on the importance of the key phrase 114. For example, identifying the key phrase 114 may further comprise determining a level of importance for the key phrase 114 (such as by using a machine learning model trained to assess key phrase importance or based on configured rules), and the key phrase embedding 118 may be assigned a weight based on the determined level of importance. As another example, the weights may be adjusted based on the results of classification (e.g., the weight of the key phrase embedding 118 may be iteratively increased or decreased based on incorrect classifications of texts).

Certain embodiments provide that more than one key phrase 114 may be identified for a given text. In such embodiments, the weight associated with key phrase embeddings 118 may be split between the key phrase embeddings 118. For example, 0.8 may be the weight allocated for the text embedding 116 and 0.2 may be the weight allocated for key phrase embeddings 118. Thus, if there are two key phrases 114, the weight of each key phrase embedding 118 may be 0.1. Alternatively, a given weight may be allocated for each key phrase embedding 118. For example, 0.2 may be the weight allocated for each key phrase embedding 118. Thus, if there are two key phrases 114, the weight for each key phrase embedding 118 may be 0.2 and the weight for the text embedding 116 may be 0.6. Other weight combinations are possible. For example, a weight of 0 may be assigned to the text embedding 116 and a weight of one may be assigned to the key phrase embedding 118. The result of the concatenation and weighting may be a weighted embedding representation 122 of text 112.

The classification model 140 may be trained through a supervised learning process based on the weighted embedding representation 122. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. For example, parameters of the classification model 140 may be iteratively adjusted until the classification model 140 assigns a correct class to the training text when provided with the weighted embedding representation 122 or until one or more other conditions occur. As a result of training the classification model 140 using embeddings that are weighted based on key phrases that indicate a correct class for a training text, the classification model 140 may be optimized for the particular classification task For example, the classification model 140 may be more likely to assign a text to the correct class based on the key phrase being present within the text because the model has been adjusted to associate the key phrase with the correct class.

Once trained, the classification model 140 may be used to classify texts 112 submitted by users 102. Embeddings of user-submitted texts may be created and provided to the classification model 140 directly. In other embodiments, identification module 110 may be used to identify key phrases within the user-provided texts. For example, a semantic similarity algorithm (e.g., a nearest neighbor algorithm) or other text similarity algorithm may be used to identify key phrases within the embedding of the user-provided text. This identification may be based on searching a database that contains a list of identified key phrases and/or key phrase embeddings 118. Certain embodiments provide that a key phrase may be removed from the database based on the key phrase appearing in two texts (e.g., training texts or user-provided texts) that are ultimately assigned to different classes (e.g., because such a key phrase may not be indicative of a class for texts). When a key phrase is identified within a user-provided text, a weighted embedding representation 122, as described above, may be created for the user-provided text. Then, the user-provided text may be classified based on the weighted embedding representation 122.

### Sequence Diagram for Training a Text Classification Model

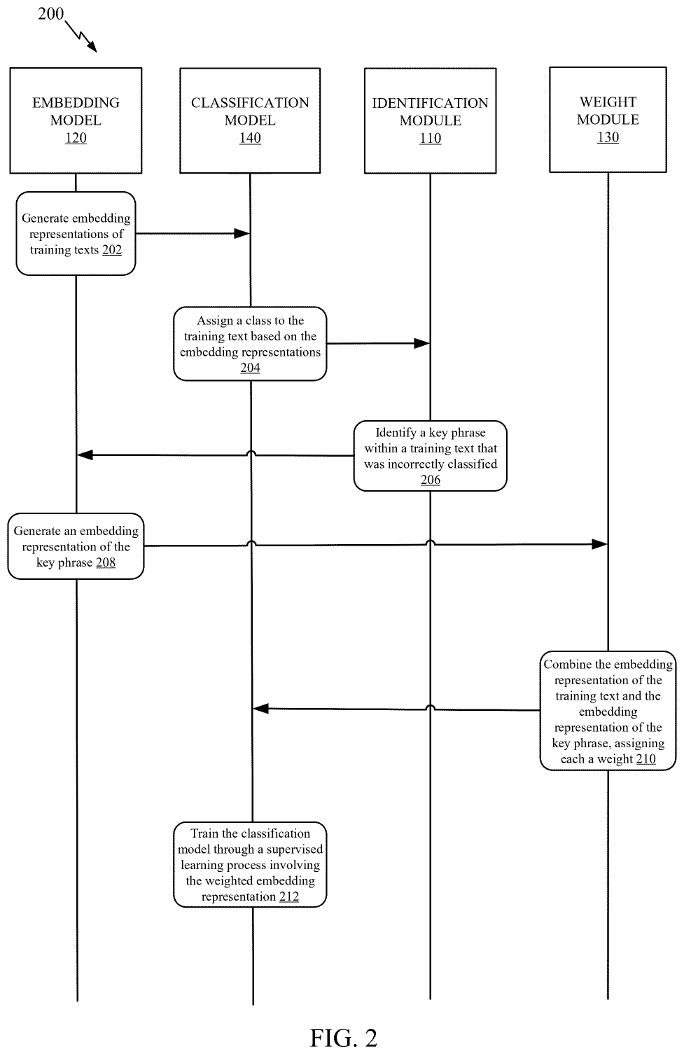

FIG. 2 illustrates a sequence diagram 200 for training a text classification model according to some embodiments of the present disclosure. Sequence diagram 200 includes identification module 110, embedding model 120, weight module 130, and classification model 140 of FIG. 1.

At 202, embedding model 120 generates embedding representations of training texts. As discussed above, the training texts may be collections of words such as phrases, sentences, and/or the like that include labels that indicate a correct class for the text. The embedding representations may allow classification model 140 to assign a class to the text. In some embodiments, an embedding representation of a given text (e.g., training text) comprises embedding representations of individual words, phrases, utterances, and/or other components within the given text, such as concatenated together and/or otherwise combined to form the embedding representation of the given text.

At 204, classification model 140 assigns a class to the training text based on the embedding representation. The class may be a correct class (e.g., a class that matches a label associated with the training text) or the class may be an incorrect class (e.g., a class that does not match a label associated with the training text).

At 206, if an incorrect class is assigned to the training text, identification module 110 may identify a key phrase within the training text. Key phrase identification may be performed manually or automatically, such as by using a machine learning model that is trained to identify key phrases for a given classification task or using a semantic similarity algorithm to identify key phrases based on searching an embedding of a user-provided text for key phrases contained within a database.

At 208, an embedding representation of the identified key phrase may be generated.

At 210, the weight module 130 may combine the embedding representation of the key phrase with the embedding representation of the training text. The weight module 130 may assign weights to the key phrase embedding and the training text embedding, as described above. As a result, a weighted embedding representation of the training text may be produced.

At 212, the weighted embedding representation of the training text is used to train the classification model 140. For example, parameters of the classification model 140 may be iteratively adjusted based on comparing classes output by the classification model 140 to the correct class, such as until the classification model assigns a correct class to the training text based on the updated embedding representation of the training text and/or until one or more other conditions are met. As a result, the classification model 140 may be optimized for the particular classification task (e.g., because the classification model 140 has been adjusted to associate the key phrase with the correct class).

### Sequence Diagram for Classifying Texts Using a Trained Text Classification Model

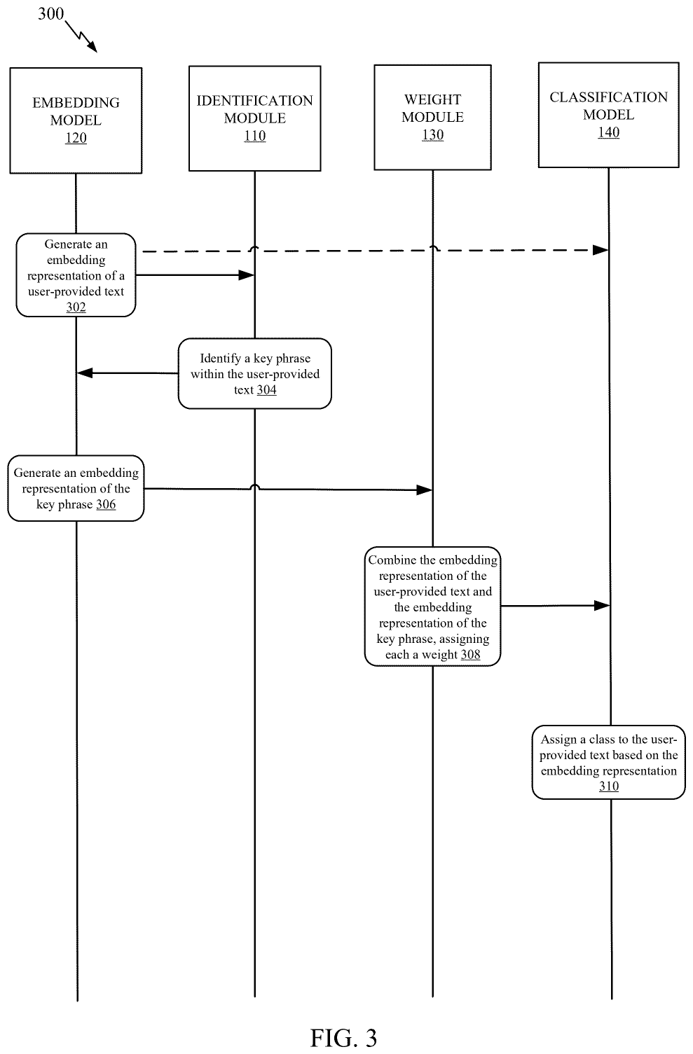

FIG. 3 illustrates a sequence diagram 300 for using a trained text classification model to classify text according to some embodiments of the present disclosure. Sequence diagram 300 includes identification module 110, embedding model 120, weight module 130, and classification model 140 of FIG. 1.

At 302, embedding model 130 is used to generate an embedding representation of a user-provided text. In some embodiments, the embedding representation is then provided to identification module 110. In alternate embodiments, the embedding representation is provided to classification model 140, the user-provided phrase is classified based on the embedding representation, and other steps such as identifying key phrases, creating embedding representations of key phrases, and assigning weights to key phrases are bypassed.

At 304, identification module 110 identifies a key phrase within the user-provided text. As discussed above with respect to FIG. 2, key phrase identification may be performed manually or automatically, such as by using a machine learning model that is trained to identify key phrases for a given classification task or using a semantic similarity algorithm to identify key phrases based on searching an embedding of a user-provided text for key phrases contained within a database (e.g., a database may include key phrases and/or embeddings of key phrases associated with particular classification tasks, classifications, and/or domains).

At 306, embedding model 130 is used to generate an embedding representation of the key phrase.

At 308, weight module 120 is used to combine the embedding representation of the user-provided text and the embedding representation of the key phrase and assign each a weight. As a result, a weighted embedding representation of the user-provided text may be produced.

At 310, the weighted embedding representation of the user-provided text is provided to the classification model 140, which classifies the user-provided text based on the weighted embedding representation. As discussed above, the classification model 140 may alternatively classify the user-provided text based on the embedding representation of the user-provided text generated at 310.

### Example Operations Related to Training a Text Classification Model

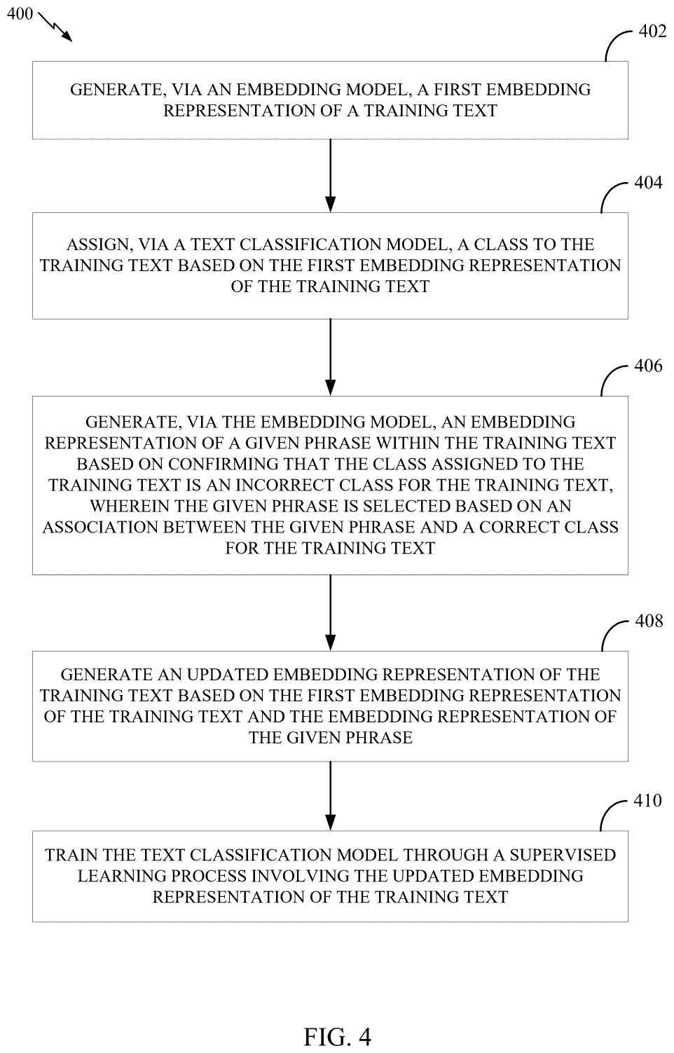

FIG. 4 depicts example operations 400 related to training a text classification model. For example, operations 400 may be performed by one or more of the components described in FIG. 1.

Operations 400 begin at step 402 with generating, via an embedding model, a first embedding representation of a training text.

Operations 400 continue at step 404 with assigning, via a text classification model, a class to the training text based on the first embedding representation of the training text.

Operations 400 continue at step 406 with generating, via the embedding model, an embedding representation of a given phrase within the training text based on confirming that the class assigned to the training text is an incorrect class for the training text, wherein the given phrase is selected based on an association between the given phrase and a correct class for the training text. Certain embodiments provide that the given phrase is selected from a set of phrases identified as being associated with the correct class. In some embodiments, the given phrase is selected based on applying a semantic similarity algorithm to detect the given phrase within the training text based on the first embedding representation.

Operations 400 continue at step 408 with generating an updated embedding representation of the training text based on the first embedding representation of the training text and the embedding representation of the given phrase. In some embodiments, generating the updated embedding representation comprises combining the first embedding representation and the embedding representation of the given phrase, wherein a respective weight is assigned to each of the first embedding representation and the embedding representation of the given phrase.

Operations 400 continue at step 410 with training the text classification model through a supervised learning process involving the updated embedding representation of the training text. Certain embodiments provide that the supervised learning process comprises updating parameters of the text classification model based on comparing the correct class for the training text to one or more classes output by the text classification model based on the updated embedding representation of the training text. In some embodiments, the trained text classification model is used to assign a given class to a given text. According to certain embodiments, assigning the given class to the given text comprises: generating an embedding representation of the given text; generating a revised embedding representation of the given text based on detecting a particular phrase of a set of phrases in the given text, wherein the set of phrases were selected based on an association between each phrase of the set of phrases and an incorrect classification of a respective text that contains the phrase; and classifying the given text based on the revised embedding representation using the trained text classification model.

In certain embodiments, a second phrase within the training text is selected based on the second phrase not being relevant for assigning classes; an embedding representation of the second phrase is generated; a negative weight is assigned to the embedding representation of the second phrase; and creating the updated embedding representation of the training text is further based on the embedding representation of the second phrase.

### Example Operations Related to Training a Text Classification Model

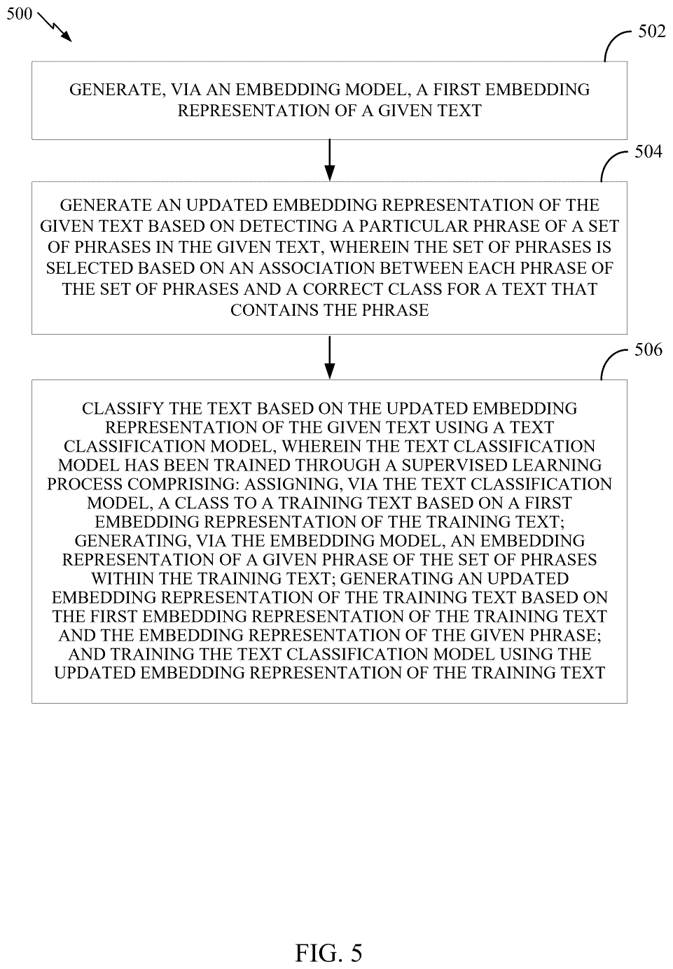

FIG. 5 depicts example operations 500 related to training a text classification model. For example, operations 500 may be performed by one or more of the components described in FIG. 1.

Operations 500 begin at step 502 with generating, via an embedding model, a first embedding representation of a given text.

Operations 500 continue at step 504 with generating an updated embedding representation of the given text based on detecting a particular phrase of a set of phrases in the given text, wherein the set of phrases is selected based on an association between each phrase of the set of phrases and a correct class for a text that contains the phrase. In some embodiments, generating the updated embedding representation of the given text comprises combining the first embedding representation of the given text and the embedding representation of the particular phrase, wherein a respective weight is assigned to each of the first embedding representation of the given text and the embedding representation of the particular phrase. Certain embodiments provide that the detecting is based on applying a semantic similarity algorithm to the first embedding representation of the given text.

Operations 500 continue at step 506 with classifying the text based on the updated embedding representation of the given text using a text classification model, wherein the text classification model has been trained through a supervised learning process comprising: assigning, via the text classification model, a class to a training text based on a first embedding representation of the training text; generating, via the embedding model, an embedding representation of a given phrase of the set of phrases within the training text; generating an updated embedding representation of the training text based on the first embedding representation of the training text and the embedding representation of the given phrase; and training the text classification model using the updated embedding representation of the training text. According to some embodiments, the supervised learning process further comprises updating parameters of the text classification model based on comparing a correct class for the training text to one or more classes output by the text classification model based on the updated embedding representation of the training text.

### Example of a Processing System for Text Classification

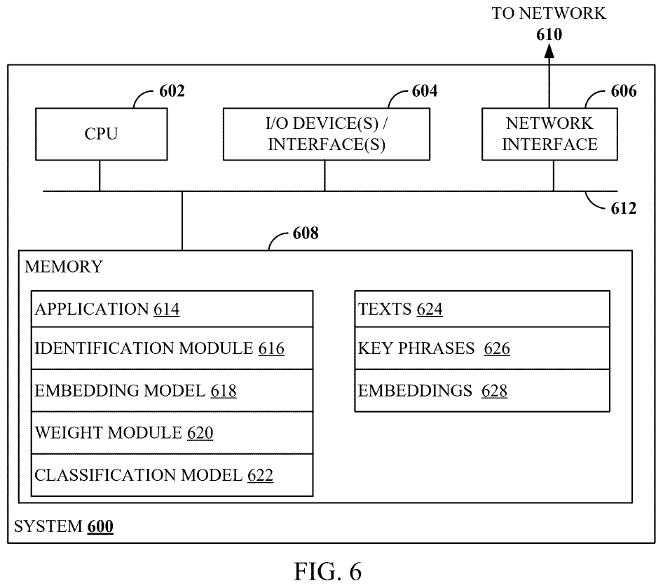

FIG. 6 illustrates an example system 600 with which embodiments of the present disclosure may be implemented. For example, system 600 may be configured to perform operations 400 of FIG. 4 or operations 500 of FIG. 5 and/or to implement one or more components as in FIG. 1.

System 600 includes a central processing unit (CPU) 602, one or more I/O device interfaces that may allow for the connection of various I/O devices 604 (e.g., keyboards, displays, mouse devices, pen input, etc.) to the system 600, network interface 606, a memory 608, and an interconnect 612. It is contemplated that one or more components of system 600 may be located remotely and accessed via a network 610. It is further contemplated that one or more components of system 600 may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes application 614, identification module 616, embedding model 618, weight module 620, and classification model 622. Application 614 may be representative of an application associated with user interface 104 of FIG. 1. In some embodiments, identification module 616 may be representative of identification module 110 of FIG. 1, FIG. 2, and FIG. 3. Embedding model 618 may be representative of embedding model 120 of FIG. 1, FIG. 2, and FIG. 3. Weight module 620 may be representative of weight module 130 of FIG. 1. Classification model 622 may be representative of classification model 140 of FIG. 1, FIG. 2, and FIG. 3.

Memory 608 further comprises texts 624, which may correspond to text 112 of FIG. 1. Memory 608 further comprises key phrases 626 which may correspond to key phrase 114 of FIG. 1. Memory 608 further comprises embeddings 628, which may include text embedding 116, key phrase embedding 118, and weighted embedding representation 122 of FIG. 1.

It is noted that in some embodiments, system 500 may interact with one or more external components, such as via network 510, in order to retrieve data and/or perform operations.

Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training a text classification model, comprising:
generating, via an embedding model, a first embedding representation of a training text;
assigning, via a text classification model, a class to the training text based on the first embedding representation of the training text;
generating, via the embedding model, an embedding representation of a given phrase within the training text based on confirming that the class assigned to the training text is an incorrect class for the training text, wherein the given phrase is selected based on an association between the given phrase and a correct class for the training text;
generating an updated embedding representation of the training text based on the first embedding representation of the training text and the embedding representation of the given phrase; and
training the text classification model through a supervised learning process involving the updated embedding representation of the training text.

2. The method of claim 1, wherein generating the updated embedding representation comprises combining the first embedding representation and the embedding representation of the given phrase, wherein a respective weight is assigned to each of the first embedding representation and the embedding representation of the given phrase.

3. The method of claim 2, wherein:
a second phrase within the training text is selected based on the second phrase not being relevant for assigning classes;
an embedding representation of the second phrase is generated;
a negative weight is assigned to the embedding representation of the second phrase; and
creating the updated embedding representation of the training text is further based on the embedding representation of the second phrase.

4. The method of claim 1, wherein the supervised learning process comprises updating parameters of the text classification model based on comparing the correct class for the training text to one or more classes output by the text classification model based on the updated embedding representation of the training text.

5. The method of claim 1, wherein the given phrase is selected from a set of phrases identified as being associated with the correct class.

6. The method of claim 5, wherein the given phrase is selected based on applying a semantic similarity algorithm to detect the given phrase within the training text based on the first embedding representation.

7. The method of claim 1, wherein the trained text classification model is used to assign a given class to a given text.

8. The method of claim 7, wherein assigning the given class to the given text comprises:
generating an embedding representation of the given text;
generating a revised embedding representation of the given text based on detecting a particular phrase of a set of phrases in the given text, wherein the set of phrases were selected based on an association between each phrase of the set of phrases and an incorrect classification of a respective text that contains the phrase; and
classifying the given text based on the revised embedding representation using the trained text classification model.

9. A method of classifying text, comprising:
generating, via an embedding model, a first embedding representation of a given text;
generating an updated embedding representation of the given text based on detecting a particular phrase of a set of phrases in the given text, wherein the set of phrases is selected based on an association between each phrase of the set of phrases and a correct class for a text that contains the phrase; and
classifying the text based on the updated embedding representation of the given text using a text classification model, wherein the text classification model has been trained through a supervised learning process comprising:
assigning, via the text classification model, a class to a training text based on a first embedding representation of the training text;
generating, via the embedding model, an embedding representation of a given phrase of the set of phrases within the training text;
generating an updated embedding representation of the training text based on the first embedding representation of the training text and the embedding representation of the given phrase; and
training the text classification model using the updated embedding representation of the training text.

10. The method of claim 9, wherein generating the updated embedding representation of the given text comprises combining the first embedding representation of the given text and the embedding representation of the particular phrase, wherein a respective weight is assigned to each of the first embedding representation of the given text and the embedding representation of the particular phrase.

11. The method of claim 9, wherein the supervised learning process further comprises updating parameters of the text classification model based on comparing a correct class for the training text to one or more classes output by the text classification model based on the updated embedding representation of the training text.

12. The method of claim 9, wherein the detecting is based on applying a semantic similarity algorithm to the first embedding representation of the given text.

13. A system for training a text classification model, comprising:
one or more processors; and
a memory comprising instructions that, when executed by the one or more processors, cause the system to:
generate, via an embedding model, a first embedding representation of a training text;
assign, via a text classification model, a class to the training text based on the first embedding representation of the training text;
generate, via the embedding model, an embedding representation of a given phrase within the training text based on confirming that the class assigned to the training text is an incorrect class for the training text, wherein the given phrase is selected based on an association between the given phrase and a correct class for the training text;
generate an updated embedding representation of the training text based on the first embedding representation of the training text and the embedding representation of the given phrase; and
train the text classification model through a supervised learning process involving the updated embedding representation of the training text.

14. The system of claim 13, wherein generating the updated embedding representation comprises combining the first embedding representation and the embedding representation of the given phrase, wherein a respective weight is assigned to each of the first embedding representation and the embedding representation of the given phrase.

15. The system of claim 14, wherein:
a second phrase within the training text is selected based on the second phrase not being relevant for assigning classes;
an embedding representation of the second phrase is generated;
a negative weight is assigned to the embedding representation of the second phrase; and
creating the updated embedding representation of the training text is further based on the embedding representation of the second phrase.

16. The system of claim 13, wherein the supervised learning process comprises updating parameters of the text classification model based on comparing the correct class for the training text to one or more classes output by the text classification model based on the updated embedding representation of the training text.

17. The system of claim 13, wherein the given phrase is selected from a set of phrases identified as being associated with the correct class.

18. The system of claim 17, wherein the given phrase is selected based on applying a semantic similarity algorithm to detect the given phrase within the training text based on the first embedding representation.

19. The system of claim 13, wherein the trained text classification model is used to assign a given class to a given text.

20. The system of claim 19, wherein assigning the given class to the given text comprises:
generating an embedding representation of the given text;
generating a revised embedding representation of the given text based on detecting a particular phrase of a set of phrases in the given text, wherein the set of phrases were selected based on an association between each phrase of the set of phrases and an incorrect classification of a respective text that contains the phrase; and
classifying the given text based on the revised embedding representation using the trained text classification model.
